(19) United States
(12) Patent Application Publication
(10) Pub. No.: US 2024/0142984 A1
(43) Pub. Date: May 2, 2024

(54) Systems and Methods for Updating Maps for Robotic Navigation

(71) Applicant: ZEBRA TECHNOLOGIES CORPORATION, Lincolnshire, IL (US)

(72) Inventors: Melonee Wise, San Jose, CA (US); Annelise Pruitt, San Jose, CA (US); Benjamin Narin, Lincolnshire, IL (US); Aoran Jiao, Mississauga (CA); Peter Arandorenko, Mississauga (CA); Tori Fujinami, Lincolnshire, IL (US); Vishnu Sudheer Menon, Sunnyvale, CA (US)

(21) Appl. No.: 17/975,378

(22) Filed: Oct. 27, 2022

(51) Int. Cl. G05D 1/02; G05D 1/00

(52) U.S. Cl. CPC G05D 1/0274; G05D 1/0061; G05D 1/0238; G05D 2201/0216

(57) ABSTRACT

A method in a computing device includes: storing an initial map representing objects within a facility; receiving sensor data from a mobile robot deployed in the facility, the sensor data representing a portion of the facility within a field of view of the mobile robot; determining, based on the received sensor data, whether a map update criterion is satisfied; in response to determining that the map update criterion is satisfied, generating a map update representing updated objects within the facility; applying the map update to the initial map to generate an updated map; and storing the updated map.

### BACKGROUND

Autonomous or semi-autonomous mobile robots can be deployed in facilities such as warehouses, manufacturing facilities, healthcare facilities, or the like, e.g., to transport items within the relevant facility. To navigate a facility, a mobile robot may generate a path through the facility based on a previously generated map of the facility, e.g., indicating the locations of various obstacles in the facility. The location of obstacles may change over time, however, rendering the map less accurate, which may impede navigation by the mobile robots.

### BRIEF DESCRIPTION OF THE SEVERAL VIEWS OF THE DRAWINGS

The accompanying figures, where like reference numerals refer to identical or functionally similar elements throughout the separate views, together with the detailed description below, are incorporated in and form part of the specification, and serve to further illustrate embodiments of concepts that include the claimed invention, and explain various principles and advantages of those embodiments.

FIG. 1 is a diagram of an item-handing mobile robot deployed in a facility.

FIG. 2 is a diagram of certain components of a mobile robot of FIG. 1.

FIG. 3 is a flowchart illustrating a method of updating a facility map.

FIG. 4 is a diagram illustrating an example performance of block 305 of the method of FIG. 3.

FIG. 5 is a diagram illustrating an example performance of block 310 of the method of FIG. 3.

FIG. 6 is a diagram illustrating another example performance of blocks 305 and 310 of the method of FIG. 3.

FIG. 7 is a diagram illustrating another example performance of block 315 of the method of FIG. 3.

FIG. 8 is a diagram illustrating an example performance of blocks 330, 335, and 340 of the method of FIG. 3.

FIG. 9 is a diagram illustrating a time-lapse of historical map data stored at block 340 of the method of FIG. 3.

FIG. 10 is a diagram illustrating an example performance of blocks 305a and 305b of the method of FIG. 3.

FIG. 11 is a diagram illustrating another example performance of block 305 of the method of FIG. 3.

Skilled artisans will appreciate that elements in the figures are illustrated for simplicity and clarity and have not necessarily been drawn to scale. For example, the dimensions of some of the elements in the figures may be exaggerated relative to other elements to help to improve understanding of embodiments of the present invention.

The apparatus and method components have been represented where appropriate by conventional symbols in the drawings, showing only those specific details that are pertinent to understanding the embodiments of the present invention so as not to obscure the disclosure with details that will be readily apparent to those of ordinary skill in the art having the benefit of the description herein.

### DETAILED DESCRIPTION

Examples disclosed herein are directed to a method in a computing device including: storing an initial map representing objects within a facility; receiving sensor data from a mobile robot deployed in the facility, the sensor data representing a portion of the facility within a field of view of the mobile robot; determining, based on the received sensor data, whether a map update criterion is satisfied; in response to determining that the map update criterion is satisfied, generating a map update representing updated objects within the facility; applying the map update to the initial map to generate an updated map; and storing the updated map.

Additional examples disclosed herein are directed to a computing device, comprising: a memory storing an initial map representing objects within a facility; and a processor configured to: receive sensor data from a mobile robot deployed in the facility, the sensor data representing a portion of the facility within a field of view of the mobile robot; determine, based on the received sensor data, whether a map update criterion is satisfied; in response to determining that the map update criterion is satisfied, generate a map update representing updated objects within the facility; apply the map update to the initial map to generate an updated map; and store the updated map in the memory.

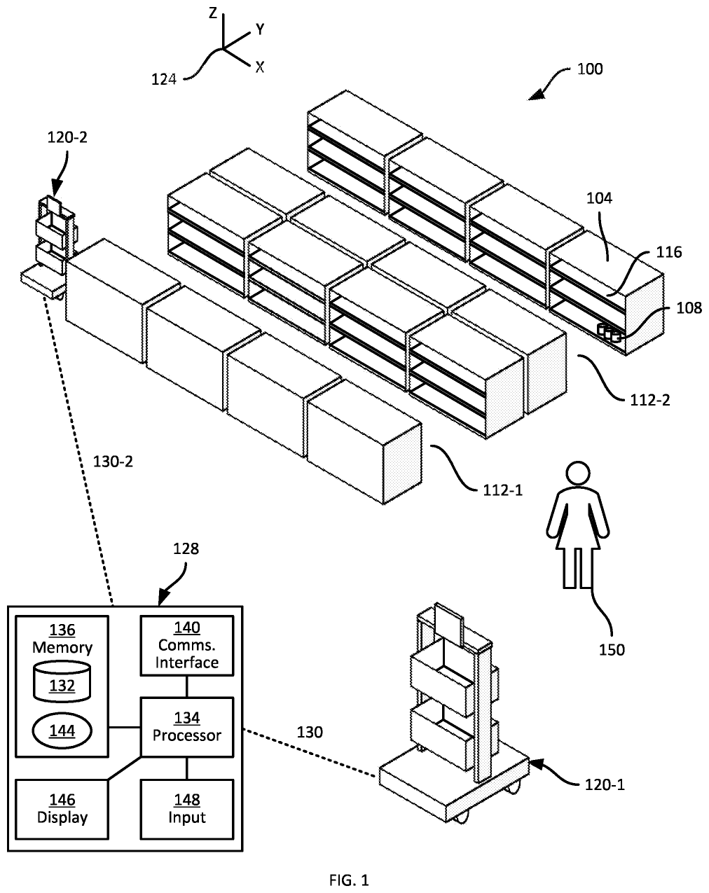

FIG. 1 illustrates an interior of a facility 100, such as a warehouse, a manufacturing facility, a healthcare facility, or the like. The facility 100 includes a plurality of support structures 104 carrying items 108. In the illustrated example, the support structures 104 include shelf modules, e.g., arranged in sets forming aisles 112-1 and 112-2 (collectively referred to as aisles 112, and generically referred to as an aisle 112; similar nomenclature is used herein for other components). As shown in FIG. 1, support structures 104 in the form of shelf modules include support surfaces 116 supporting the items 108. The support structures 104 can also include pegboards, bins, or the like, in other examples.

In other examples, the facility 100 can include fewer aisles 112 than shown, or more aisles 112 than shown in FIG. 1. The aisle 112, in the illustrated example, are formed by sets of eight support structures 104 (four on each side). The facility can also have a wide variety of other aisle layouts, however. As will be apparent, each aisle 112 is a space open at the ends, and bounded on either side by a support structure 104. The aisle 112 can be travelled by humans, vehicles, and the like. In still further examples, the facility 100 need not include aisles 112, and can instead include assembly lines, or the like.

The items 108 may be handled according to a wide variety of processes, depending on the nature of the facility 100. In some examples, the facility 100 is a shipping facility, distribution facility, or the like, and the items 108 can be placed on the support structures 104 for storage, and subsequently retrieved for shipping from the facility. Placement and/or retrieval of the items 108 to and/or from the support structures can be performed or assisted by mobile robots 120-1 and 120-2. A greater number of robots 120 can be deployed in the facility 100 than the two robots 120 shown in FIG. 1, for example based on the size and/or layout of the facility 100. Components of the robots 120 are discussed below in greater detail. In general, each robot 120 is configured to transport items 108 within the facility 100.

Each robot 120 can be configured to track its pose (e.g., location and orientation) within the facility 100, e.g., in a coordinate system 124 previously established in the facility 100. The robots 120 can navigate autonomously within the facility 100, e.g., travelling to assigned locations to receive and/or deposit items 108. The items 108 can be deposited into or onto the robots 120, and removed from the robots 120, by human workers and/or mechanized equipment such as robotic arms and the like deployed in the facility 100. The locations to which each robot 120 navigates can be assigned to the robots 120 by a central server 128. That is, the server 128 is configured to assign tasks to the robots 120. Each task can include either or both of one or more locations to travel to, and one or more actions to perform at those locations. For example, the server 128 can assign a task to the robot 120-1 to travel to a location defined in the coordinate system 124, and to await the receipt of one or more items 108 at that location.

Tasks can be assigned to the robots via the exchange of messages between the server 128 and the robots 120, e.g., over a suitable combination of local and wide-area networks implementing communications links 130-1, 130-2 with the robots 120. The server 128 can be deployed at the facility 100, or remotely from the facility 100. In some examples, the server 128 is configured to assign tasks to robots 120 at multiple facilities, and need not be physically located in any of the individual facilities.

To navigate to a given location in the facility 100 (e.g., a target location assigned to a mobile robot 120 by the server 128), a robot 120 can generate a path through the facility from its current pose to the target location. The path is generated based on a map of the facility, e.g., stored in a repository 132 at the server 128. Each robot 120 can, for example, periodically obtain a copy of the map from the server 128 for local storage and use in navigational functions such as path generation. The map stored at the server 128 represents objects within the facility 100, but generally does not represent all objects in the facility 100. Rather, the map represents permanent or semi-permanent objects (e.g., static objects that are not relocated, or are relocated infrequently) such as walls, doorways, the support structures 104, and the like. Each robot 120 can also maintain a local map of transient obstacles observed via sensor data, and can consult both maps to generate and execute navigational paths.

Although the objects represented in the “master” map at the server 132 may be relocated infrequently, when they are relocated, or when such objects are removed or added to the facility, the map in the repository 132 may become outdated. The robots 120 may therefore be provided with outdated map data by the server 128, and may therefore become mislocalized and/or generate navigational paths that intersect with objects located in previously empty space.

Updating the map at the server 128, e.g., in response to relocating a support structure 104, may be performed by manual editing of the map, but manual editing is error-prone and may be as likely to lead to navigational errors as the previous (outdated) map. The server 128 is therefore configured, as discussed below, to implement certain functions to evaluate sensor data from the robots 120 and update the map at least partially automatically.

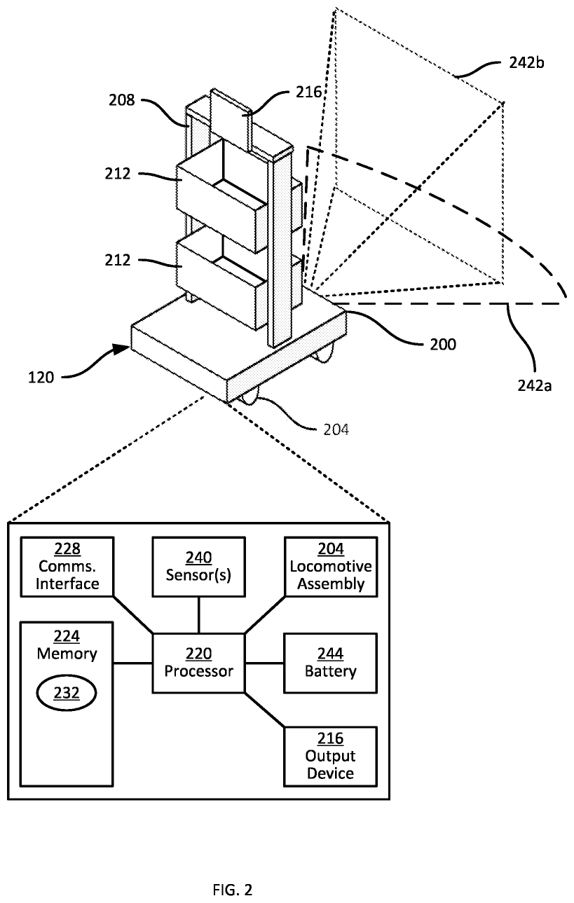

Before discussing the functionality implemented by the robot 120 in greater detail, certain components of the server 128 are discussed in connection with FIG. 1, and certain components of the robot 120 are discussed with reference to FIG. 2.

As shown in FIG. 1, the server 128 includes a processor 134, such as one or more central processing units (CPU), graphics processing units (GPU), or dedicated hardware controllers such as application-specific integrated circuits (ASICs). The processor 134 is communicatively coupled with a non-transitory computer readable medium such as a memory 136, e.g., a suitable combination of volatile and non-volatile memory elements. The processor 134 is also coupled with a communications interface 140, such as a transceiver (e.g., an Ethernet controller or the like) enabling the server 128 to communicate with other computing devices, such as the mobile robots 120. The memory 136 can store the repository 132 mentioned earlier, as well as a plurality of computer-readable instructions executable by the processor 134, such as an application 144 whose execution by the processor 134 configures the processor 134 to implement the map updating functions discussed herein.

The server 128 can further include an output device such as a display 146, and an input device 148, such as a touch screen integrated with the display 146, a keyboard and mouse, or the like. The display 146 is controllable by the processor 134 to render various information thereon, and the input device 148 receives input from an operator of the server 128 such as a worker 150 in the facility 100, and provides data representing such input to the processor 134. The display 146 and input device 148 are illustrated as components of the server 128 for simplicity, but can also be implemented as components of another computing device distinct from the server 128 and connected with the server 128 via a the previously mentioned networks. For example, the other computing device can execute a web browser application to communicate with the server 128 and receive data therefrom for presentation on the display 146.

Turning to FIG. 2, each robot 120 includes a chassis 200 supporting various other components of the robot 120. In particular, the chassis 200 supports a locomotive assembly 204, such as one or more electric motors driving a set of wheels, tracks, or the like. The locomotive assembly 204 can include one or more sensors such as a wheel odometer, an inertial measurement unit (IMU), and the like.

The chassis 200 also supports receptacles, shelves, or the like, to support items 108 during transport. For example, the robot 120 can include a selectable combination of receptacles 212. In the illustrated example, the chassis 200 supports a rack 208, e.g., including rails or other structural features configured to support receptacles 212 at variable heights above the chassis 200. The receptacles 212 can therefore be installed and removed to and from the rack 208, enabling distinct combinations of receptacles 212 to be supported by the robot 120.

The robot 120 can also include an output device, such as a display 216. In the illustrated example, the display 216 is mounted above the rack 208, but it will be apparent that the display 216 can be disposed elsewhere on the robot 120 in other examples. The display 216 can include an integrated touch screen or other input device, in some examples, The robot 120 can also include other output devices in addition to or instead of the display 216. For example, the robot 120 can include one or more speakers, light emitters such as strips of light-emitting diodes (LEDs) along the rack 208, and the like.

The chassis 200 of the robot 120 also supports various other components, including a processor 220, e.g., one or more central processing units (CPUs), graphics processing units (GPUs), or dedicated hardware controllers such as application specific integrated circuits (ASICs). The processor 220 is communicatively coupled with a non-transitory computer readable medium such as a memory 224, e.g., a suitable combination of volatile and non-volatile memory elements. The processor 220 is also coupled with a communications interface 228, such as a wireless transceiver enabling the robot 120 to communicate with other computing devices, such as the server 128 and other robots 120. The communications interface 228 can also include, in some examples, a wired interface such as a Universal Serial Bus (USB) controller and one or more USB ports, or the like.

The memory 224 stores various data used for autonomous or semi-autonomous navigation, including an application 232 executable by the processor 220 to implement navigational and other task execution functions. In some examples, the above functions can be implemented via multiple distinct applications stored in the memory 224.

The chassis 200 can also support a sensor 240, such as one or more cameras and/or depth sensors (e.g., lidars, depth cameras, time-of-flight cameras, or the like) coupled with the processor 220. The sensor(s) 240 are configured to capture image and/or depth data depicting at least a portion of the physical environment of the robot 120. Data captured by the sensor(s) 240 can by used by the processor 220 for navigational purposes, e.g., path planning, obstacle avoidance, and the like, as well as for updating a map of the facility in some examples.

The sensors 240 have respective fields of view (FOVs). For example, a first FOV 242a corresponds to a laser scanner, such as a lidar sensor disposed on a forward-facing surface of the chassis 200. The FOV 242a can be substantially two-dimensional, e.g., extending forwards in a substantially horizontal plane. A second FOV 242b corresponds to a camera (e.g., a depth camera, a color camera, or the like) also mounted on the forward-facing surface of the chassis 200. As will be apparent, a wide variety of other optical sensors can be disposed on the chassis 200 and/or the rack 208, with respective FOVs 242.

The components of the robot 120 that consume electrical power can be supplied with such power from a battery 244, e.g., implemented as one or more rechargeable batteries housed in the chassis 200 and rechargeable via a charging port (not shown) or other suitable charging interface.

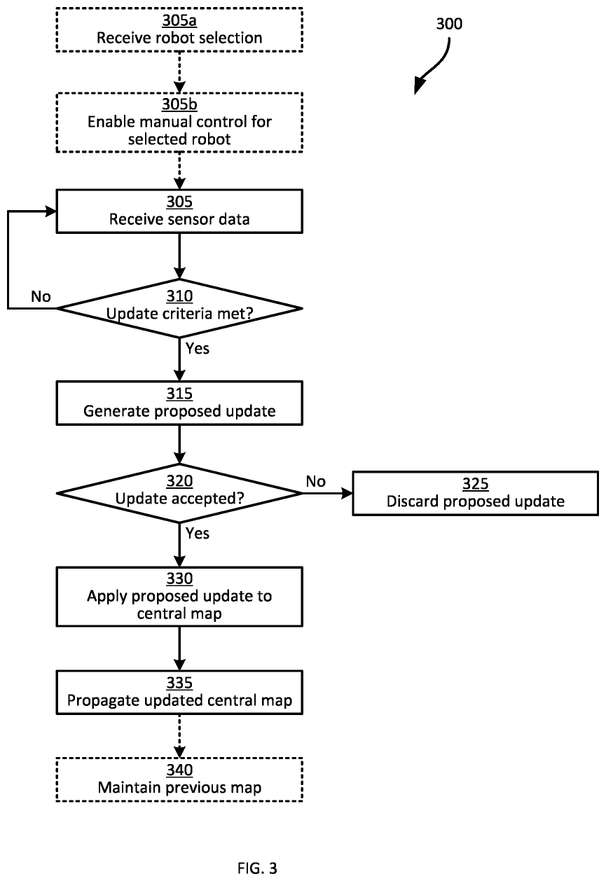

Turning to FIG. 3, a method 300 of updating a map of a facility is illustrated. The method 300 is described below in conjunction with its example performance in the facility 100. In particular, as indicated in FIG. 3, the blocks of the method 300 are performed by the server 128, e.g., via execution of the application 232 by the processor 220. In other examples, as noted below, certain blocks in the method 300 can be performed by a mobile robot 120.

The performance of the method 300 involves the collection of sensor data at the server 128 from one or more of the robots 120, and the processing of the collected sensor data to update the map of the facility 100 stored at the server 128. The sensor data can be collected from mobile robots 120 operating autonomously, e.g., to complete tasks assigned to the robots 120 by the server 128. The sensor data can also, in some examples, be collected from mobile robots 120 operating in a piloted mode, in which a human operator such as the worker 150 directs the movements of a robot 120. Blocks 305a and 305b can optionally be performed to initiate data collection using the piloted mode. In the present example performance of the method 300, blocks 305a and 305b are omitted, and sensor data is collected from robots 120 operating autonomously. Blocks 305a and 305b are discussed in greater detail further below.

At block 305, the server 128 is configured to receive sensor data from one or more robots 120. The sensor data received at block 305 can include raw sensor data from the robots 120, such as point cloud data captured via cameras and/or laser scanners. The processor 220 of the robot 120, in other words, can be configured to control the sensors(s) 240 to capture sensor data, and can then transmit the sensor data to the server 128 via the communications interface 228. In other examples, the sensor data is received as local map data, as mentioned above, e.g., in the form of images generated at the robots 120 from sensor data. The sensor data received at block 305 also includes a pose of the robot 120 that captured the sensor data, and a timestamp indicating when the sensor data was captured. The robots 120 can be configured to periodically transmit sensor data to the server 128 during the execution of tasks assigned by the server 128. More generally, at block 305 the server 128 receives, from the robots 120, current observations representing the surroundings of the robots 120.

At block 310, having received sensor data from at least one of the robots 120, the server 128 is configured to determine whether the received sensor data (as well as any previously received and stored sensor data) satisfies one or more update criteria stored at the server 128. The update criteria define conditions that, if satisfied, indicate a mismatch between objects observed in the facility 100 by the robots 120, and objects represented in the current map stored in the repository 132. In other words, when the update criteria are satisfied, the physical layout of the facility 100 is likely to have changed sufficiently that the initial map in the repository 132 is outdated.

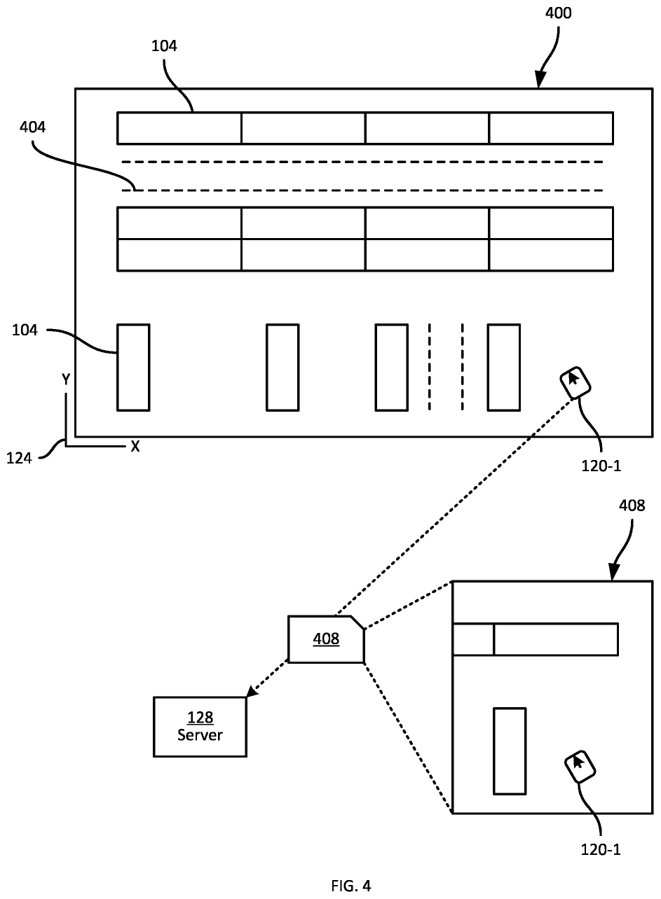

Turning to FIG. 4, an initial map 400 is illustrated, e.g., as stored in the repository 132. The initial map 400 indicates the locations of objects in the facility 100, such as support structures 104. The map 400 can be an image, e.g., representing a projection of objects in the facility 100 onto the XY plane, which may be parallel to a floor of the facility 100 such that the map 400 provides an overhead view of the facility 100. The objects represented in the map 400 are shown with boundaries in FIG. 4 for simplicity of illustration, but a wide variety of other formats can also be used to represent objects in the map 400. For example, pixels representing occupied space can have a first value (e.g., black), while pixels representing empty space can have a second value (e.g., white). In such examples, the interior of the objects represented in the map would also be black, rather than only the boundaries. In some examples, the map can include pixels having a third value, e.g., an intermediate value, indicating unobserved space whose occupancy state is not known. The initial map 400 can also include annotations, such as virtual lanes 404 that do not have a physical presence in the facility 100, but that can be employed as navigational constraints by the robots 120 (e.g., such that the robots 120 only plan paths traveling along the lanes 404 when in the corresponding aisles 112).

A current pose of the robot 120-1 is illustrated on the map 400. As will be apparent to those skilled in the art, the pose of the robot 120-1 need not be stored within the map 400, but can be periodically reported to the server 128 by the robot 120-1 and stored in the memory 136. FIG. 4 also illustrates sensor data 408 sent from the robot 120-1 to the server 128, representing objects in the vicinity of the robot 120-1 (e.g., within the sensor FOVs 242 of the robot 120-1). The sensor data 408 can also include the current pose of the robot 120-1, as well as a timestamp indicating the date and time at which the sensor data was captured by the robot 120-1. The sensor data 408 is illustrated as including complete objects, although it will be apparent to those skilled in the art that in some cases, only certain portions of the objects (e.g., the support structures 104) are visible to the sensors 240, and the sensor data 408 may therefore represent only certain edges or surfaces of the objects.

As noted above, in response to receiving the sensor data, at block 310 the server 128 is configured to determine whether update criteria are met for any portion of the facility 100 represented in the sensor data. The determination at block 310 can include, for example, determining locations (in the coordinate system 124) of objects represented in the map 400, and the locations of objects represented in the sensor data 408, and determining distances between pairs of such objects (or more generally, between pairs of occupied regions). An update criterion can include a threshold distance between such objects, such that objects separated by less than the threshold distance do not meet the update criterion, while objects separated by more than the threshold distance meet the update criterion. A wide variety of other update criteria are also contemplated, including measuring a degree of overlap between objects in the sensor data 408 and the map 400 (with an affirmative determination at block 310 requiring an overlap below a threshold).

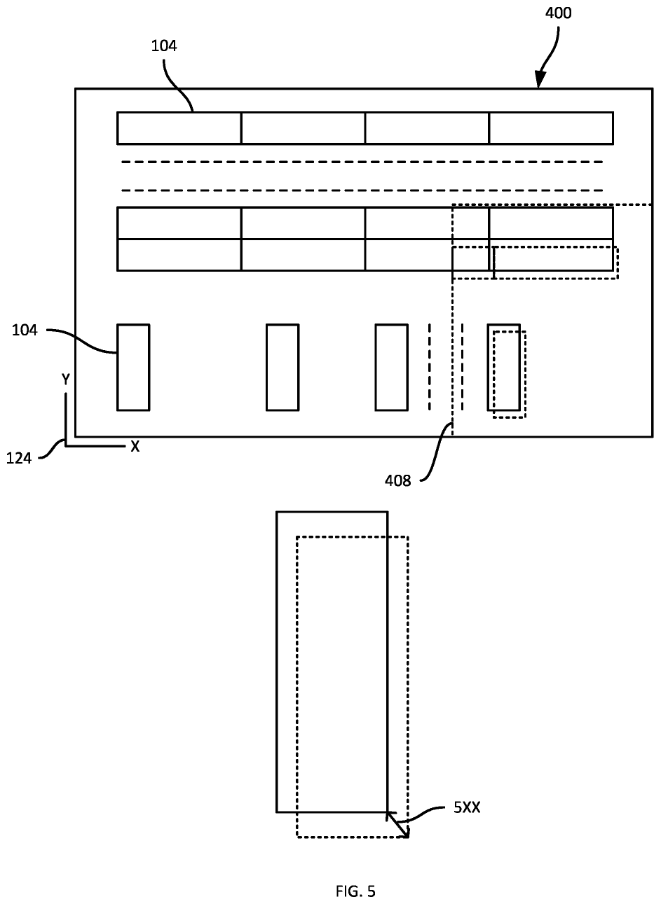

For example, turning to FIG. 5, the sensor data 408 is shown overlaid (in dashed lines) on the map 400. The server 128 can, for example, determine distances between corresponding features of objects in the sensor data 408 and objects in the map 400, such as a distance 500 between a corner of a support structure 104 from the sensor data 408, and the nearest support structure corner in the map 400. When the distance is below a threshold, the determination at block 310 can be negative, because the difference between the sensor data 408 and the map 400 is insufficient to indicate a likely relocation, addition or removal of objects from the facility 100. When the determination at block 310 is negative, the server 128 continues collecting sensor data at block 305.

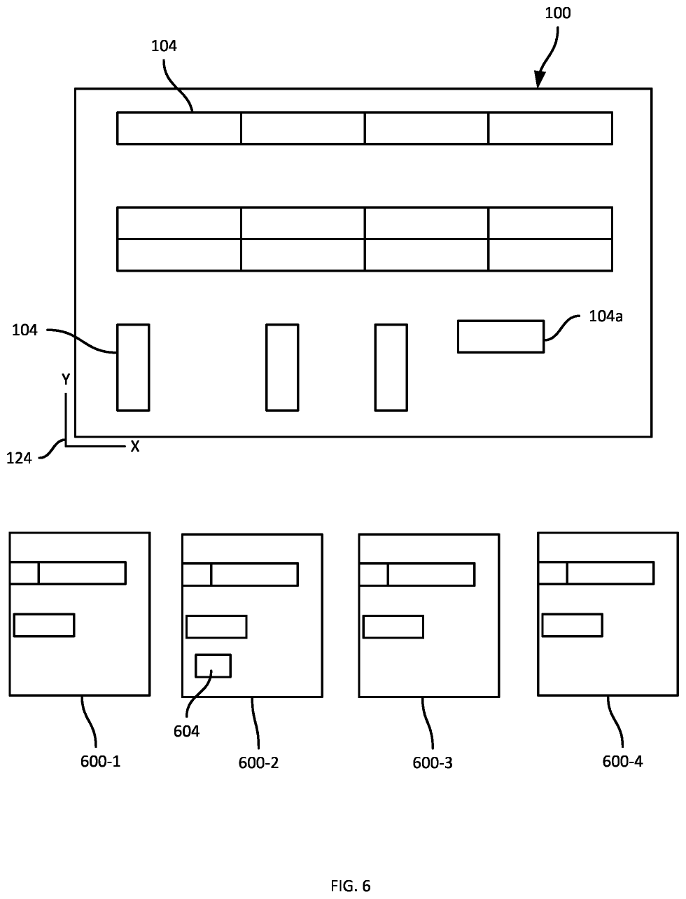

Turning to FIG. 6, an updated layout of the facility 100 is illustrated, in which a support structure 104a has been rotated and translated relative to the position of that support structure in the map 400. The map 400 has not yet been updated, and therefore no longer accurately reflects the location of the support structure 104a. FIG. 6 also illustrates four sets of sensor data 600-1, 600-2, 600-3, and 600-4, each representing a region of the facility 100 around the support structure 104a. The sensor data sets 600 can be received from the same robot 120, or from different robots 120, and can be received at different times.

Further example update criteria evaluated at block 328 include determining whether a number of instances of sensor data representing matching sets of objects exceeds a consensus threshold. The instances of sensor data may also be required to occur over at least a predetermined time period. For example, if at least three distinct sets of sensor data, spanning a capture time period of at least four days, represent one or more matching objects and those matching objects do not match the map 400, the determination at block 310 is affirmative. In this example, the sensor data sets 600 all show the new position of the support structure 104a. The sensor data 600-2 also shows another object 604, but the determination at block 310 is negative in connection with the object 604, as no other sensor data set 600 contains the object 604. The object 604 is therefore likely to be transient, rather than a static object eligible for insertion into the map 400.

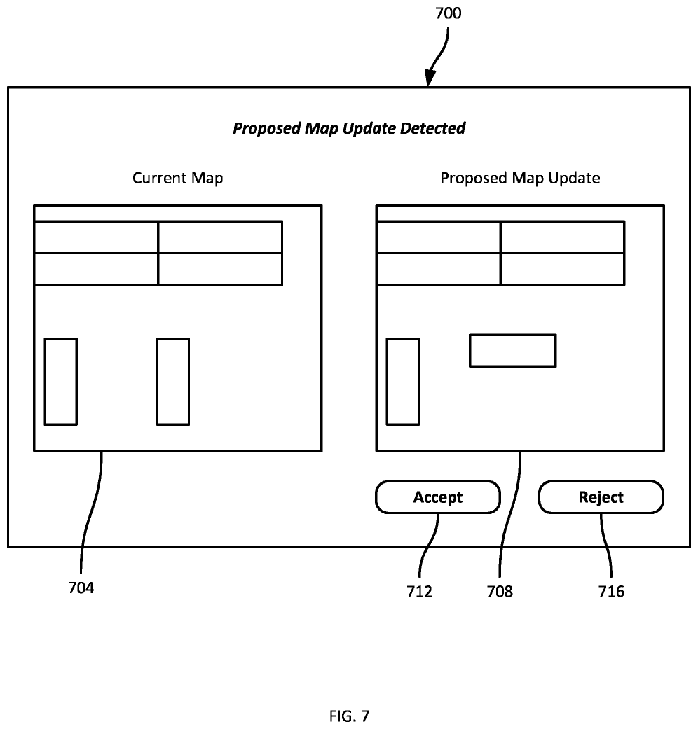

When the determination at block 310 is affirmative, as in the example of FIG. 6, the server 128 proceeds to block 315. At block 315, the server 128 is configured to generate a proposed map update, and present the proposed map update via a notification, e.g., on the display 146, via a message such as an email, or the like. Turning to FIG. 7, an example notification 700 is illustrated, e.g., generated on the display 146. The notification indicates that the server 128 has detected a potential change in the layout of the facility 100, and indicates the proposed change to the initial map 400 to reflect the detected change. For example, the notification can include a portion 704 of the initial map 400 (e.g., a portion of a predetermined area, surrounding the region of the initial map 400 to be updated), and a corresponding portion 708 (e.g., the same area of the facility 100 as in the portion 704) of the map as it appears following the update. The notification 700 also includes selectable elements 712 and 716 to accept or reject the update shown in the portion 708.

In some examples, the processor 220 of a robot 120 can perform blocks 305, 310, and 315, e.g., based on locally captured and processed sensor data. The consensus-based criteria mentioned above may be limited to repeated observations of an occupied region of the facility 100 by that robot 120, in such examples. The map update generated at block 315 can, for example, be transmitted to the server 128 for approval or rejection at block 320.

At block 320, the server 128 is configured to determine whether the proposed update, e.g., presented in the notification 700, has been accepted. Prior to the determination at block 320, the update generated at block 315 is not applied to the map 400, but can instead be stored as a separate draft map, or simply as the portion 708 in isolation. When the determination at block 320 is negative (e.g., the element 716 in FIG. 7 is selected via the input device 148), the update from block 315 can be discarded at block 325. The initial map 400, in other words, remains unchanged.

When the determination at block 320 is affirmative, e.g., in response to selection of the element 712 in FIG. 7, the server 128 proceeds to block 330. At block 330, the server 128 is configured to apply the proposed update generated at block 315 to the initial map 400, to generate an updated map. For example, the server 128 can insert the region identified at blocks 310 and 315 into the map 400, replacing the previous contents of that region. In the case of an image-based map as discussed above, for example, the pixels within the identified region of the map 400 can be updated with values according to the updated generated at block 315. In other examples, e.g., in which the map 400 is based on a graph representation of the facility 100, the graph can be updated (e.g., inserting or removing nodes and/or edges) according to the sensor data that led to the updated from block 315, and deriving an updated map image from the updated graph.

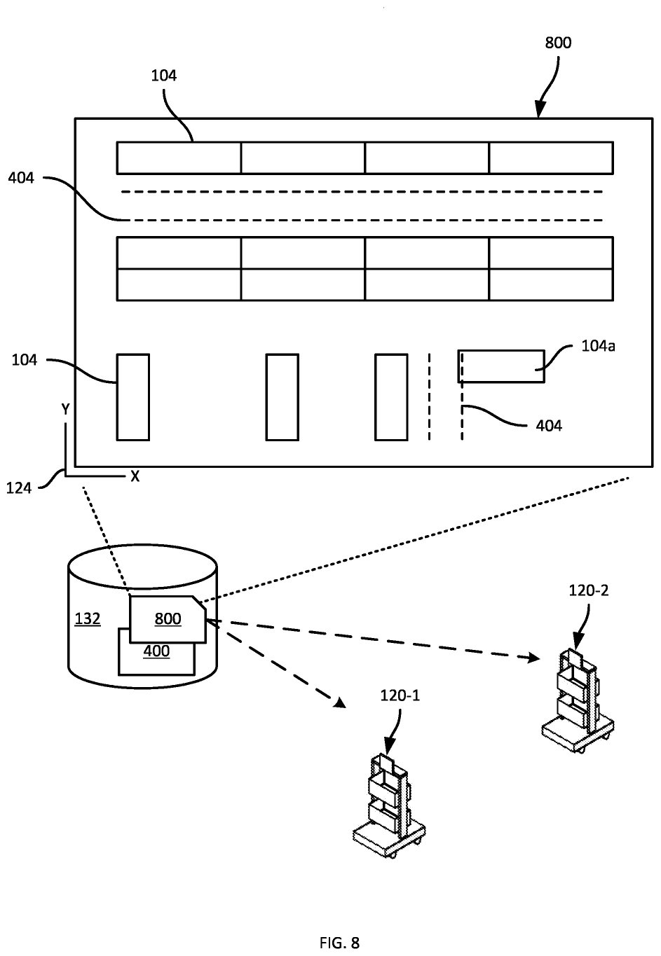

Turning to FIG. 8, an updated map 800 is shown, in which the support structure 104a has replaced a previous support structured in the map 400. The updated map 800 is stored in the repository 132, e.g., with a version number, timestamp, or the like indicating that the map 800 is the current map of the facility 100. At block 335, the server 128 can be configured to propagated the updated map 800 by transmitting copies of the map 800 to the mobile robots 120-1 and 120-2. As will be apparent, until block 335, each robot 120 can maintain a local copy of the map 400. Upon receiving the map 800, each robot 120 can discard the copy of the map 400, and instead store a local copy of the map 800.

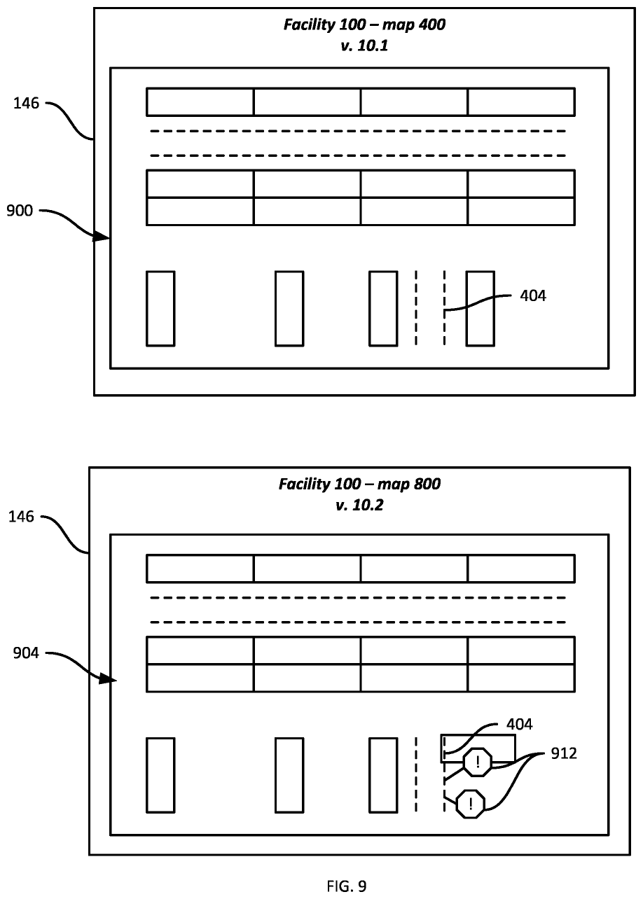

Referring again to FIG. 3, at block 340 the server 128 can optionally maintain the previous map (e.g., the initial map 400) in the repository 132. As shown in FIG. 8, both the maps 400 and 800 are maintained in the repository 132. The map 400 may be marked in the repository with a version identifier, timestamp, or the like, indicating that the map 400 is no longer the current (e.g., in active use by the robots 120) version. Maintaining previous versions of the map enables the server 128 to, in some examples, generate graphical interfaces such as time lapses illustrating a sequence of maps according to the timestamps and/or version numbers of those maps. For example, turning to FIG. 9, the server 128 can present on the display 146 a sequence of images 900 and 904, each depicting successive maps (in this example, the maps 400 and 800 in sequence). The server 128 can also present map version numbers, creation dates, or the like.

In addition, the server 128 can render indicators such as navigational errors 912 on the map that was current when the navigational errors 912 were detected (e.g., by receipt at the server 128 from one or more robots 120). Displaying navigational errors 912 or other indicators in the time lapse interface may assist operators in detecting and correcting mapping issues, such as the fact that the updated map 800 shown in the lower portion includes a virtual lane 404 that now intersects with an object, which may be associated with an increased incidence of navigational errors.

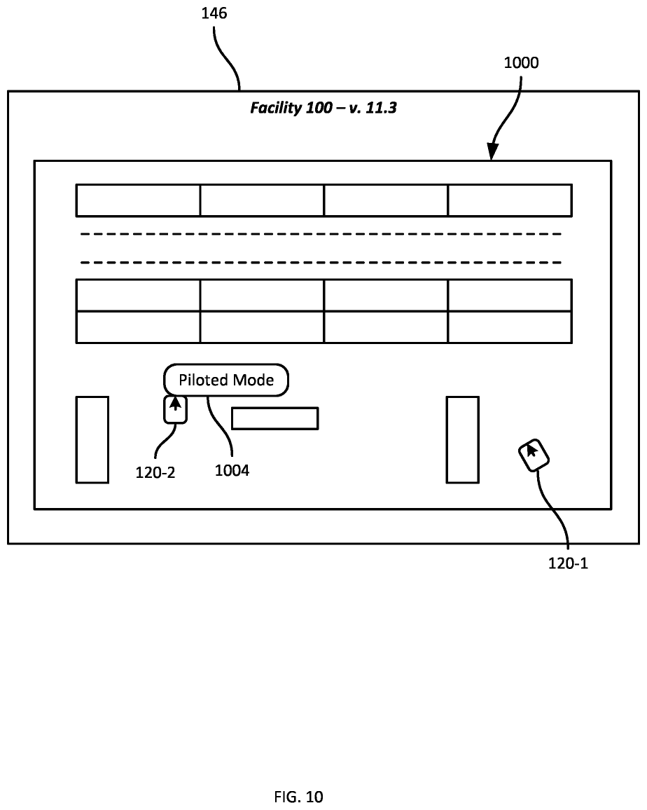

Returning to FIG. 3, as noted earlier the collection of updated map data can also be implemented via manual control of a robot 120 by an operator such as the worker 150. In such examples, at block 305a the server 128 is configured to receive a selection, via the input device 146, of a robot 120. For example, as shown in FIG. 10, the server 128 can present a current map 1000 on the display 146, along with current poses of the robots 120. As shown in FIG. 10, the worker 150 can select a robot 120 via the input device 146 to invoke various selectable elements, including a piloted mode activation element 1004. In response to receiving a selection of the element 1004 at block 305a (or in response to receiving any other suitable command to place a specifically identified robot 120 into the piloted mode), the server 128 is configured to transmit a command to the robot 120-2 to enable manual control of the robot 120-2 via a piloted mode. In the piloted mode, the robot 120-2 is not assigned any autonomous tasks by the server 128, and cannot be selected (e.g., via the user interface shown in FIG. 10) by other operators for task assignment.

In response to receiving the above command from the server 128, the robot 120-2 ceases autonomous navigation, and awaits manual control commands. The worker 150 can, for example, connect a controller (e.g., a video game controller or the like) to the communications interface 228 via Bluetooth, a USB dongle, or the like. The worker 150 can then directly control the path of the mobile robot 120-2. As the robot 120-2 travels under the control of the worker 150, the robot 120-2 captures sensor data and transmits the sensor data to the server 128, which receives the sensor data as described above in connection with block 305.

When the sensor data received at block 305 is received from a robot 120 under manual control, the determination at block 310 is affirmative. For example, the determination at block 310 can be omitted when the piloted mode is active, or an update criterion can be configured to determine whether the sensor data was received from a robot 120 in the piloted mode. As will be apparent, the consensus-based features discussed earlier (e.g., a given feature in the facility 100 being observed by a number of robots 120 over a period of time) can therefore be bypassed. The server 128 is therefore configured to proceed to block 315, and generate a proposed update, based on the sensor data from block 305. The server 128 can be configured to present the proposed update on the display 146, e.g., in real time as the robot 120-2 is piloted within the facility 100, enabling the worker 150 or other staff to monitor sensor data collection.

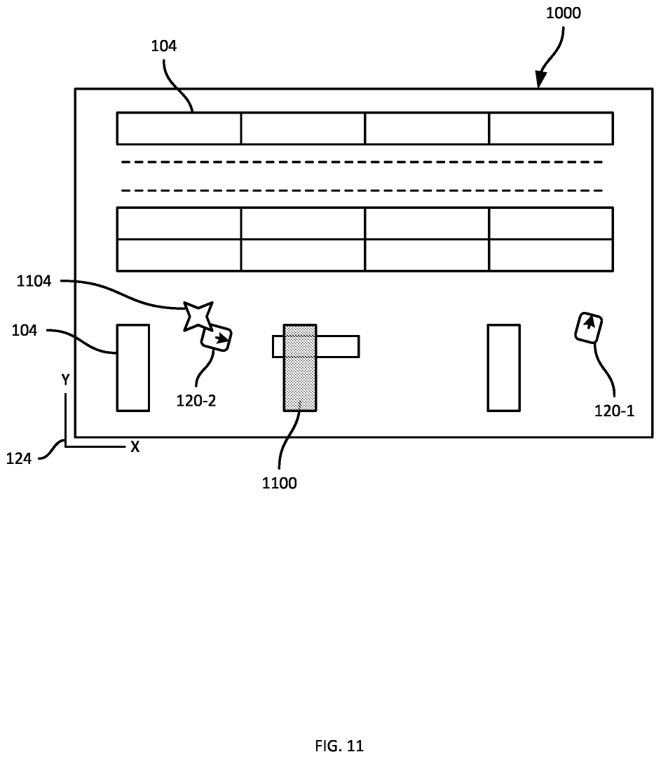

For example, turning to FIG. 11, the map 1000 is shown with new sensor data 1100 overlaid thereon, e.g., with a different color, shading, or the like, distinguishing the sensor data 1100 from the map 1000. For example, the server 128 can store the sensor data 1100 separately from the map 1000 (because the map 1000 has not yet been updated), but display both sensor data 1100 and map 1000 simultaneously. As also shown in FIG. 11, the current pose of the robot 120-2 can be displayed along with an icon 1104 indicating that the robot 120-2 is currently being operated in the piloted mode, and is therefore unavailable for selection for other tasks. As seen in FIG. 11, the robot 120-2 is being piloted to re-map a portion of the facility 100. In other examples, the same functionality can be employed to map a previously unmapped portion of the facility 100, effectively extending the boundaries of the map 1000.

At block 320, e.g., in response to completion of the piloting of the robot 120-2 (e.g., as indicated by further input data from the input device 148 defining a command to release the robot 120-2 from the piloted mode, the server 128 can be configured to present an interface similar to that shown in FIG. 7 to prompt an operator for acceptance or rejection of the map update.

The functionality implemented by the server 128 thus enables updating maps for the facility 100 in an at least partially automated manner, avoiding the potential for erroneous edits to the maps that may result from manual updating.

In the foregoing specification, specific embodiments have been described. However, one of ordinary skill in the art appreciates that various modifications and changes can be made without departing from the scope of the invention as set forth in the claims below. Accordingly, the specification and figures are to be regarded in an illustrative rather than a restrictive sense, and all such modifications are intended to be included within the scope of present teachings.

The benefits, advantages, solutions to problems, and any element(s) that may cause any benefit, advantage, or solution to occur or become more pronounced are not to be construed as a critical, required, or essential features or elements of any or all the claims. The invention is defined solely by the appended claims including any amendments made during the pendency of this application and all equivalents of those claims as issued.

Moreover in this document, relational terms such as first and second, top and bottom, and the like may be used solely to distinguish one entity or action from another entity or action without necessarily requiring or implying any actual such relationship or order between such entities or actions. The terms “comprises,” “comprising,” “has”, “having,” “includes”, “including,” “contains”, “containing” or any other variation thereof, are intended to cover a non-exclusive inclusion, such that a process, method, article, or apparatus that comprises, has, includes, contains a list of elements does not include only those elements but may include other elements not expressly listed or inherent to such process, method, article, or apparatus. An element proceeded by “comprises . . . a”, “has . . . a”, “includes . . . a”, “contains . . . a” does not, without more constraints, preclude the existence of additional identical elements in the process, method, article, or apparatus that comprises, has, includes, contains the element. The terms “a” and “an” are defined as one or more unless explicitly stated otherwise herein. The terms “substantially”, “essentially”, “approximately”, “about” or any other version thereof, are defined as being close to as understood by one of ordinary skill in the art, and in one non-limiting embodiment the term is defined to be within 10%, in another embodiment within 5%, in another embodiment within 1% and in another embodiment within 0.5%. The term “coupled” as used herein is defined as connected, although not necessarily directly and not necessarily mechanically. A device or structure that is “configured” in a certain way is configured in at least that way, but may also be configured in ways that are not listed.

Certain expressions may be employed herein to list combinations of elements. Examples of such expressions include: “at least one of A, B, and C”; “one or more of A, B, and C”; “at least one of A, B, or C”; “one or more of A, B, or C”. Unless expressly indicated otherwise, the above expressions encompass any combination of A and/or B and/or C.

It will be appreciated that some embodiments may be comprised of one or more specialized processors (or “processing devices”) such as microprocessors, digital signal processors, customized processors and field programmable gate arrays (FPGAs) and unique stored program instructions (including both software and firmware) that control the one or more processors to implement, in conjunction with certain non-processor circuits, some, most, or all of the functions of the method and/or apparatus described herein. Alternatively, some or all functions could be implemented by a state machine that has no stored program instructions, or in one or more application specific integrated circuits (ASICs), in which each function or some combinations of certain of the functions are implemented as custom logic. Of course, a combination of the two approaches could be used.

Moreover, an embodiment can be implemented as a computer-readable storage medium having computer readable code stored thereon for programming a computer (e.g., comprising a processor) to perform a method as described and claimed herein. Examples of such computer-readable storage mediums include, but are not limited to, a hard disk, a CD-ROM, an optical storage device, a magnetic storage device, a ROM (Read Only Memory), a PROM (Programmable Read Only Memory), an EPROM (Erasable Programmable Read Only Memory), an EEPROM (Electrically Erasable Programmable Read Only Memory) and a Flash memory. Further, it is expected that one of ordinary skill, notwithstanding possibly significant effort and many design choices motivated by, for example, available time, current technology, and economic considerations, when guided by the concepts and principles disclosed herein will be readily capable of generating such software instructions and programs and ICs with minimal experimentation.

The Abstract of the Disclosure is provided to allow the reader to quickly ascertain the nature of the technical disclosure. It is submitted with the understanding that it will not be used to interpret or limit the scope or meaning of the claims. In addition, in the foregoing Detailed Description, it can be seen that various features are grouped together in various embodiments for the purpose of streamlining the disclosure. This method of disclosure is not to be interpreted as reflecting an intention that the claimed embodiments require more features than are expressly recited in each claim. Rather, as the following claims reflect, inventive subject matter lies in less than all features of a single disclosed embodiment. Thus the following claims are hereby incorporated into the Detailed Description, with each claim standing on its own as a separately claimed subject matter.

1. A method in a computing device, comprising:
storing an initial map representing objects within a facility;
obtaining sensor data from a sensor of a mobile robot deployed in the facility, the sensor data representing a portion of the facility within a field of view of the mobile robot;
determining, based on the received sensor data, whether a map update criterion is satisfied;
in response to determining that the map update criterion is satisfied, generating a map update representing updated objects within the facility;
applying the map update to the initial map to generate an updated map; and
storing the updated map.

2. The method of claim 1, wherein the map includes an image, each pixel having a first value to indicate occupied space, or a second value to indicate empty space.

3. The method of claim 1, wherein obtaining the sensor data includes receiving the mobile data at a processor of the mobile robot; the method further comprising, in response to determining at the processor that the map update criterion is satisfied, generating the map update and transmitting the map update from the processor to a server.

4. The method of claim 1, further comprising: transmitting the updated map to the mobile robot and a plurality of additional mobile robots deployed in the facility.

5. The method of claim 1, wherein determining whether the map update criterion is satisfied includes:
determining a first location of a first occupied region in the sensor data;
determining a second location of a second occupied region in a portion of the initial map corresponding to the sensor data; and
determining whether a difference between the first location and the second location exceeds a threshold.

6. The method of claim 1, further comprising:
receiving further sensor data representing the portion of the facility from a second mobile robot;
wherein determining whether the map update criterion is satisfied includes:
determining that the sensor data and the further sensor data represent a matching subset of obstacles.

7. The method of claim 6, wherein determining whether the map update criterion is satisfied further includes: determining that the sensor data and the further sensor data were captured at times separated by a threshold time period.

8. The method of claim 1, wherein determining whether the map update criterion is satisfied includes determining that the mobile robot is operating in a piloted mode.

9. The method of claim 8, further comprising:
prior to receiving the sensor data, receiving a command to set the mobile robot to the piloted mode; and
transmitting a command to the mobile robot to enable the piloted mode.

10. The method of claim 1, further comprising:
prior to applying the map update, presenting a notification including the map update; and
in response to presenting the notification, receiving a command to apply the map update.

11. The method of claim 1, further comprising: marking the updated map as a current version, and marking the initial map as a previous version.

12. The method of claim 11, further comprising: rendering a time lapse interface including the initial map and the updated map in sequence.

13. The method of claim 12, further comprising:
receiving navigational events from the mobile robot and having respective timestamps; and
rendering the navigational events in the time lapse interface overlaid on either the initial map or the updated map, according to the timestamps.

14. A computing device, comprising:
a memory storing an initial map representing objects within a facility; and
a processor configured to:
obtain sensor data from a sensor of a mobile robot deployed in the facility, the sensor data representing a portion of the facility within a field of view of the mobile robot;
determine, based on the received sensor data, whether a map update criterion is satisfied;
in response to determining that the map update criterion is satisfied, generate a map update representing updated objects within the facility;
apply the map update to the initial map to generate an updated map; and
store the updated map in the memory.

15. The method of claim 14, wherein the map includes an image, each pixel having a first value to indicate occupied space, or a second value to indicate empty space.

16. The computing device of claim 15, wherein the processor is configured to obtain the sensor data by controlling the sensor of the mobile robot to capture the sensor data; and
wherein the processor is further configured, in response to determining that the map update criterion is satisfied, to generate the map update and transmit the map update to a server.

17. The computing device of claim 14, wherein the processor is configured to: transmit the updated map to the mobile robot and a plurality of additional mobile robots deployed in the facility.

18. The computing device of claim 14, wherein the processor is configured to determine whether the map update criterion is satisfied by:
determining a first location of a first occupied region in the sensor data;
determining a second location of a second occupied region in a portion of the initial map corresponding to the sensor data; and
determining whether a difference between the first location and the second location exceeds a threshold.

19. The computing device of claim 14, wherein the processor is configured to:
receive further sensor data representing the portion of the facility from a second mobile robot; and
determine whether the map update criterion is satisfied by determining that the sensor data and the further sensor data represent a matching subset of obstacles.

20. The computing device of claim 19, wherein the processor is configured to determine whether the map update criterion is satisfied further by determining that the sensor data and the further sensor data were captured at times separated by a threshold time period.

21. The computing device of claim 14, wherein the processor is configured to determine whether the map update criterion is satisfied by determining that the mobile robot is operating in a piloted mode.

22. The computing device of claim 21, wherein the processor is configured to:
prior to receiving the sensor data, receive a command to set the mobile robot to the piloted mode; and
transmit a command to the mobile robot to enable the piloted mode.

23. The computing device of claim 14, wherein the processor is configured to:
prior to applying the map update, present a notification including the map update; and
in response to presenting the notification, receive a command to apply the map update.

24. The computing device of claim 14, wherein the processor is configured to: mark the updated map as a current version, and marking the initial map as a previous version.

25. The computing device of claim 24, wherein the processor is configured to: render a time lapse interface including the initial map and the updated map in sequence.

26. The computing device of claim 25, wherein the processor is configured to:
receive navigational events from the mobile robot and having respective timestamps; and
render the navigational events in the time lapse interface overlaid on either the initial map or the updated map, according to the timestamps.
